(19) United States
(12) Patent Application Publication
(10) Pub. No.: US 2007/0184980 A1
(43) Pub. Date: Aug. 9, 2007

(54) Manufacture and use of herbicide chlorinated phenoxy formulation

(75) Inventors: Johnnie R. Roberts, Arlington, TN (US); Gregory C. Volgas, Bartlett, TN (US); Peter T. Delashmit, Memphis, TN (US)

Correspondence Address: Connolly Bove Lodge & Hutz LLP, 1007 North Orange Street, P.O. Box 2207, Wilmington, DE, 19899, US

(73) Assignee: HELENA HOLDING COMPANY, Wilmington, DE (US)

(21) Appl. No.: 11/698,581

(22) Filed: Jan. 25, 2007

Related U.S. Application Data
(60) Provisional application No. 60/762,096, filed on Jan. 25, 2006.

(51) Int. Cl. A01N 43/40; A01N 47/10

(52) U.S. Cl. 504/118; 504/258; 504/303

(57) ABSTRACT

The invention pertains to a method for increasing the activity of chlorinated phenoxy herbicides by specially formulating said herbicides with a combination of solvent and selected surfactants. This method requires the use of alkylated fatty esters and an alkaline buffer. This unique combination of components has been seen to allow lower use rates of chlorinated phenoxy herbicides while also providing a stable formulation.

### CROSS REFERENCE RELATED TO APPLICATION

The present application claims the benefit of provisional application Ser. No. 60/762,096, filed Jan. 25, 2006, for all useful purposes, and the specification thereof is included herein by reference.

### BACKGROUND OF THE INVENTION

As early as 1988, Henkel Corporation began marketing a line of methylated fatty acids, and more specifically, methylated soybean oil, as a replacement for commonly used organic solvents used in pesticide formulations. These methyl esters were and still are, promoted as being safer solvents because of their high flash point, relative to more commonly used aromatic hydrocarbons. In 1986, F. A. Manthey, et. Al., published a paper showing their work on various alkylated esters of different natural oils (soybean and sunflower). This work demonstrated that alkylated esters of soybean oil and sunflower oil can enhance the uptake of oxime herbicides (commonly referred to as “dims” or graminicides, i.e. sethoxydim, clopropoxydim.), and 2-(4-aryloxyphenoxy)alkanoic acid herbicides (commonly known as “fops”, i.e. diclofop, quizalofop, fluazifop). In 1989, Hazen, et al. demonstrated the effectiveness of a methylated sunflower oil adjuvant on the uptake of sethoxydim. Furthermore, it was reported that methylated sunflower oil could actually increase the stability of sethoxydim in direct sunlight. Also in 1989, Manthey, et al. reported that alkylated vegetable oils such as soybean oil and sunflower oil, could increase the relative wax solubility of pesticide sprays. In 1991, more work was done by Urvoy, et Al. That demonstrated the effectiveness of alkylated fatty acids in enhancing the uptake of graminicides. In 1993, Serre, et al. reported that alkyl esters of oleic acid could enhance the efficacy of quizalofop-ethyl, a 2-(4-aryloxyphenoxy)alkanoic acid herbicide, and phenmedipham, a bis-carbamate herbicide. In 1995, McMullan, et al. demonstrated the effectiveness of methylated fatty acids in enhancing the efficacy of trialkoxydim, another graminicide herbicide.

Phenoxy acid compounds comprise a family of herbicides that are used in the form of their parent acids, and more commonly as their salts and esters. The most common member of this herbicide family is 2,4-D [(2,4-dichlorophenoxy)acetic acid]. Two other commonly used compounds in this family are 2,4,5-T [(2,4,5-trichlorophenoxy)acetic acid] and MCPA [[(4-chloro-o-tolyl)oxy]acetic acid]. Additional herbicides in this family are 2,4-DB [4(2,4-dichlorophenoxy)butyric acid], MCPB [4-[(4-chloro-o-tolyl)oxy]butyric acid], silvex [2-(2,4,5-trichlorophenoxy)propionic acid], dichlorprop [2-(2,4-dichlorophenoxy)propionic acid], mercoprop [2-[(4-chloro-o-tolyl)oxy]propionic acid]. These herbicides are plant growth regulator compounds with hormone-like activity.

The ester forms of these compounds are represented by the alkyl esters (mainly methyl, isopropyl, butyl, and octyl) and the low-volatile esters (butoxyethanol, propyleneglycolbutylether, and iso-octyl). The low molecular weight alkyl esters are typically not used in agriculture in the US due to their higher tendency to volatilize and drift. For example, the methyl, isopropyl or butyl esters of 2,4-D are not approved for use in the United States. The iso-octyl ester of 2,4-D is the only approved ester.

The salt forms of these phenoxy herbicides are typically amines. Specifically, 2,4-D has been sold in the dimethylamine salt form. Dicamba has been sold in the diglycolamine salt form. Other examples are known as well. In no cases, however, is it known to combine the salt and ester forms since the ester forms are typically oil soluble and the salt forms are typically water soluble. Furthermore, it takes roughly equal molar ratios of the herbicide to the amine to fully form the salts. Furthermore, when making these phenoxy salt herbicides, the phenoxy acid herbicide in the acid form is reacted with the amine.

The major controllable factors of phenoxy herbicides have been reported by Ashton and Crafts as being pH, concentration, and additives (i.e. surfactants). Absorption of phenoxy herbicides is reported to be optimal at low pH ranges. While surfactants have been reported to enhance the activity of phenoxy herbicides in some instances, no one surfactant could be selected which consistently enhanced the uptake of the herbicide. The authors cite work done by Bukovac in 1976 showing that foliar penetration is generally linearly related to the external herbicide concentration.

Recently, the family of 2,4-D herbicides has come under regulatory scrutiny due to the potential of spray mixes to drift to off-target areas. This drift is caused by volatilization of both sprays and of spray deposits. Therefore, it would be beneficial if the per acre use rate of these compounds could be reduced, thereby affording a reduction in driftable herbicide. Any attempt to reduce herbicide drift, however, must not demonstrate a reduction in herbicide efficacy.

U.S. Pat. No. 6,232,272 (Roberts, et al.), discloses a composition which comprises at least one chlorinated phenoxy herbicide, at least one alkylated fatty acid, alkylated plant derived oil or alkylated animal derived oil, and at least one surfactant. However, it has surprisingly been found that formulations of this type may be flawed. When these formulations contain ester or acid forms of the herbicide, the active ingredient may become unstable and the formulation may also lead to the formation of unwanted esters of the acid herbicide.

### SUMMARY OF THE INVENTION

The present invention is a homogenous agricultural liquid composition containing at least one phenoxy herbicide and at least one alkylated fatty acid or natural oil, and at least one alkaline buffer. These formulations are storage stable and are seen to exhibit synergistic effects allowing a reduction of herbicide use rates on a per acre basis. For the purposes of this new invention, storage stable means that the formulation retains it's physical form and condition and retains the chemical stability of the phenoxy herbicide, after at least 30 days of exposure to temperature extremes of 4 degrees C. to 45 degrees C. A key indicator of the degradation of the phenoxy acetic acid herbicide is the formation of unwanted alkyl esters of 2,4-dichlorophenoxyacetic acid. For example, in blends containing methylated fatty acids and iso-octyl ester of 2,4-D, the iso-octyl ester 2,4-D can trans-esterify with the methylated fatty acids to form methyl ester of 2,4-D. The presence of this alkyl ester of 2,4-D is a clear indicator that the original iso-octyl ester of 2,4-D has broken down.

### DETAILED DESCRIPTION OF THE NEW INVENTION

Surprisingly, it has been discovered that formulations containing phenoxy herbicides in the ester form and alkylated fatty acids or natural oils can be further enhanced by the addition of alkaline buffers, and that these formulations are storage stable. Furthermore, these formulations are such that the effective use rate of the composition can be reduced dramatically. This is in opposition to prior knowledge that the uptake of phenoxy herbicides is directly associated with the concentration of the herbicide on the plant leaf surface.

As discussed previously, these alkaline buffered forms of phenoxy herbicides are different from the traditional amine salts. The amine salts are produced by reacting the acid form of the herbicide with the amine. In the present invention, the amine is being added to an ester form of the phenoxy herbicide. In some cases, the commercially available phenoxy ester technicals may contain up to 5% of the unreacted phenoxy acid. In these instances, it would be anticipated that the added amine reacts with the acid form of the herbicide. What is significantly different in the present invention is that said reaction between the acid herbicide and the amine takes place in the presence of the ester form of the same phenoxy herbicide.

As an example of the nature of the problem, two formulations were prepared. Formula I contained 80% of the iso-octyl ester of 2,4-Dichlorophenoxy acetic acid, and 20% of methylated soybean oil. Formula II contained 80% of the iso-octyl ester of 2,4-Dichlorophenoxy acetic acid, and 20% of an aromatic hydrocarbon solvent. Both formulations were prepared by adding the components to a beaker and stirring on a magnetic stir plate. No heat was added. After 30 days in storage at 45 degrees C., the samples were analyzed using High Pressure Liquid Chromatography (HPLC). Formula I was found to contain only 73.1% of iso-octyl ester of 2,4-D and 2.2% of the methyl ester of 2,4-D. This degradation of iso-octyl ester and subsequent formation of methyl esters exemplifies the problem which this invention is designed to remedy. Under the same storage conditions, Formula II was found to contain 79.9% of the iso-octyl ester of 2,4-D and, not surprisingly, no methyl ester of 2,4-D. It would be preferable, however, to have the methylated soybean oil in the formula for reasons mentioned in prior art.

One would expect that the addition of an amine to an ester formulation would degrade the ester and create some amount of an amine salt of the phenoxy herbicide. An amine salt would not normally be soluble in the ester formulation, and would thus fall out. The following formulations were prepared by mixing the components in a beaker and heating the formulations to 50 degrees C. The solutions were then removed from heat and allowed to return to room temperature (20-25 degrees C.). tested:

### Example A

| Ingredients | % by weight |
|---|---|
| 2,4-D Iso-octyl ester | 82.4 |
| Methylated soybean oil | 12.1 |
| Nonionic emulsifier | 5.0 |
| Ethanolamine | 0.5 |

### Example B

| Ingredients | % by weight |
|---|---|
| 2,4-D Iso-octyl ester | 82.4 |
| Methylated soybean oil | 12.1 |
| Nonionic emulsifier | 5.0 |
| Dimethylamine | 0.5 |

### Example C

| Ingredients | % by weight |
|---|---|
| 2,4-D Iso-octyl ester | 82.4 |
| Methylated soybean oil | 12.1 |
| Nonionic emulsifier | 5.0 |
| Dimethylamine | 0.5 |

After only 1 hour at ambient temperature, Example A formulation formed crystals and solid precipitant. This is the expected result from the addition of an amine into an ester formulation. This also indicates the need to test each herbicide formulation with different alkaline buffers in order to properly select the correct one for stable formulations.

After 30 days at elevated temperature (45 degrees C.), Examples B and C formulations continued to be clear liquid formulations. This was also true of the cold storage (4 degrees C.) samples of formulations B and C.

The following formulations were tested:

| | Formulation ID | | | | | |
|---|---|---|---|---|---|---|
| | 1 | 2 | 3 | 4 | 5 | 6 |
| Ingredients | Percentage of each ingredient used in each formula | | | | | |
| 2,4-D Iso-octyl | 82.4 | 82.0 | 82.0 | 80.0 | 82.4 | 82.4 |
| ester | | | | | | |
| Methylated | 12.6 | — | — | 20.0 | 10.6 | 12.1 |
| soybean oil | | | | | | |
| Methylated | — | 13.0 | — | — | — | — |
| coconut oil | | | | | | |
| Methyl Oleate | — | — | 13.0 | — | — | — |
| Emulsifier A | 4.0 | 4.0 | 4.0 | — | 4.0 | 4.0 |
| Emulsifier B | 1.0 | 1.0 | 1.0 | — | 1.0 | 1.0 |
| Isopropylamine | — | — | — | — | 2.0 | — |
| Dimethylamine | — | — | — | — | — | 0.5 |

The ingredients of each separate formula were placed into a beaker and heated to 50 degrees C., then allowed to return to room temperature (25 degrees C.).

2,4-D iso-octyl ester technical contains roughly 94% of the iso-octyl ester of 2,4-D and 6% inerts.

Emulsifier A and B are surfactants specially formulated by Stepan to provide stable emulsions of 2,4-D ester formulations in water or fertilizer solutions.

Methylated soybean oil is a methylated natural oil derived from soybean oil. It is manufactured by several U.S. and foreign producers (i.e. Cognis, Witco, Stepan) by the reaction of methanol and soybean oil.

Methylated coconut oil is a methylated natural oil derived from coconut oil. It is manufactured by several U.S. and foreign producers (i.e. Cognis, Witco) by the reaction of methanol and coconut oil.

Methyl oleate is a methylated refined fatty acid. It is manufactured by several U.S. and foreign producers (i.e. Cognis, Witco) by the reaction of methanol and oleic acid.

Example formulations 1 through 4 serve as representatives of the prior art described in U.S. Pat. No. 6,232,272 (Roberts, et al.). Example 1 serves as a test control in this study.

All formulations produced clear, amber colored solutions. They were then tested for storage stability:

Samples were placed at ambient, 4 degrees C., and 45 degrees C. for 30 days. After 30 days, the samples were removed from the storage and evaluated.

| | Formulation ID | | | | | |
|---|---|---|---|---|---|---|
| Test | 1 | 2 | 3 | 4 | 5 | 6 |
| Parameter | Test results for each formulation | | | | | |
| % methyl | 7.1% | 5.4% | 3.3% | 2.2% | No | No |
| esters of 2,4- | | | | | detection | detection |
| D after 1 | | | | | | |
| month in 45 | | | | | | |
| degrees C. | | | | | | |
| storage | | | | | | |
| Physical | Remains a | Remains a | Remains a | Remains a | Remains a | Remains a |
| form stability | liquid. | liquid. | liquid. | liquid. | liquid. | liquid. |
| after 1 | Acceptable. | Acceptable. | Acceptable. | Acceptable. | Acceptable. | Acceptable. |
| month in | | | | | | |
| storage | | | | | | |

The presence of the methyl ester of 2,4-D in formulations 1 through 4 is a clear indicator that the iso-octyl ester of 2,4-D has broken down. The benefit of the two formulations using the present invention (formulations 5 and 6) is evident by the lack of the detection of any amount of methyl ester of 2,4-D. Formulations 1 through 4 would not be commercially viable in the United States since they contain the banned herbicide: methyl ester of 2,4-D. Formulations 5 and 6 would be commercially viable in the agricultural or non-agricultural sectors of the United States pesticide market.

The preferred embodiment of the present invention includes the ester form of phenoxy herbicides, including but not limited to:

Synthetic auxins including, but not limited to:

Benzoic acids such as but not limited to chloramben and dicamba,

Phenoxy-carboxylic acids such as but not limited to 2,4,5-trichlorophenoxy acetic acid, 2,4-dichlorophenoxy acetic acid, 2,4-dichlorophenoxy butyric acid, clomeprop, dichlorprop, dichlorprop-P, monochlorophenoxy acetic acid, monochlorophenoxy butyric acid, mecoprop, and mecoprop-P.

Pyridine carboxylic acids such as but not limited to clopyralid, fluroxypyr, picloram and triclopyr.

Quinoline carboxylic acids such as but not limited to quinclorac and quinmerac.

Another class of herbicides for which this invention would be useful are the aryloxyphenoxypropionates (also known as FOP's). These herbicides include but are not limited to: clodinafop-propargyl, cyhalofop-butyl, diclofop-methyl, fenoxaprop-p-ethyl, fluazifop-p-butyl, haloxyfop-ethoxyethyl, haloxyfop-etotyl, haloxyfop-methyl, haloxyfop-R-methyl, propaquizafop, quizalofop-p-ethyl, quizalofop-p-tefuryl.

The most preferred embodiment of the present invention includes 2,4-dichlorophenoxyacetic acid and its' iso-octyl ester.

The preferred embodiment of the present invention includes alkylated fatty acids or natural oils, including but not limited to the following:

Alkylated soybean oil

Alkylated sunflower oil

Alkylated canola oil

Alkylated fatty acids including C₆₋₁₈ saturated and unsaturated fatty acids.

The preferred embodiment of the present invention includes additional surfactants to enhance the spreading characteristics of the spray deposit. These surfactants preferably include those listed in the prior patents U.S. Pat. No. 5,393,791 and U.S. Pat. No. 5,580,567 which are incorporated by reference herein.

The preferred embodiment of the present invention includes an alkaline buffer. The more preferred embodiment of the present invention includes an amine. The most preferred embodiment of the present invention includes a primary or secondary amine, including but not limited to isopropylamine or dimethylamine.

All the references discussed in this application are incorporated by reference in their entirety for all useful purposes.

What is claimed is:

1. A composition which comprises
(a) at least one phenoxy herbicide in the ester form,
(b) at least one alkylated fatty acid, alkylated plant derived oil or alkylated animal derived oil, and
(c) an alkaline buffering agent.

2. The composition as claimed in claim 1, wherein the phenoxy herbicide is a benzoic acid derivative.

3. The composition as claimed in claim 2, wherein the benzoic acid derivative is chloramben or dicamba.

4. The composition as claimed in claim 1, wherein the phenoxy herbicide is a phenoxy-carboxylic acid.

5. The composition as claimed in claim 4, wherein the phenoxy-carboxylic acid is 2,4,5-trichlorophenoxy acetic acid, 2,4-dichlorophenoxy acetic acid, 2,4-dichlorophenoxy butyric acid, clomeprop, dichlorprop, dichlorprop-P, monochlorophenoxy acetic acid, monochlorophenoxy butyric acid, mecoprop, or mecoprop-P or combinations thereof.

6. The composition as claimed in claim 1, wherein the phenoxy herbicide is a pyridine carboxylic acid.

7. The composition as claimed in claim 6, wherein the pyridine carboxylic acid is clopyralid, fluroxypyr, picloram, triclopyr or combinations thereof.

8. The composition as claimed in claim 1, wherein the phenoxy herbicide is a quinoline carboxylic acid.

9. The composition as claimed in claim 8, wherein the quinoline carboxylic acid is quiclorac, quinmerac or combinations thereof.

10. The composition as claimed in claim 1, wherein the phenoxy herbicide is an aryloxyphenoxypropionate.

11. The composition as claimed in claim 10, wherein the aryloxyphenoxypropionate is clodinafop-propargyl, cyhalofop-butyl, diclofop-methyl, fenoxaprop-p-ethyl, fluazifop-p-butyl, haloxyfop-ethoxyethyl, haloxyfop-etotyl, haloxyfop-methyl, haloxyfop-R-methyl, propaquizafop, quizalofop-p-ethyl, quizalofop-p-tefuryl, or combinations thereof.

12. The composition as claimed in claim 1, wherein the phenoxy herbicide is a nitrile compound.

13. The composition as claimed in claim 12, wherein the nitrile compound is bromoxynil, ioxynil, or combinations thereof.

14. The composition as claimed in claim 5 wherein the phenoxy herbicide is the iso-octyl ester of 2,4-dichlorophenoxy acetic acid.

15. The composition as claimed in claim 1, wherein at least one alkylated fatty acid is present and at least one alkylated fatty acid is methyl oleate, ethyl oleate, methyl linoleate, ethyl linoleate, methyl laurate, ethyl laurate, methyl palmitate, ethyl palmitate, methyl stearate or ethyl stearate.

16. The composition as claimed in claim 1, which further comprises at least one surfactant selected from the groups consisting of:
a) sorbitan fatty acids,
b) sorbitan fatty acid esters,
c) ethoxylated sorbitan fatty acid esters
d) propoxylated fatty acid esters,
e) silicone containing surfactants
f) ethoxylated fatty acids,
g) branched and linear alkyl ethoxylates and phosphate or carboxylate acid esters thereof,
h) alkylphenol ethoxylates and phosphate or carboxylate acid esters thereof,
i) polypropylene glycols,
j) polyethylene glycols,
k) block copolymers of ethylene oxide and propylene oxide and phosphate or carboxylate acid esters thereof
l) fatty alkanolamides
n) tristyrylphenol alkoxylates,
o) amine ethoxylates,
p) n-acyl sarcosines or sodium n-acyl sarcosinates,
q) alkylaryl polyethoxy phosphate ester,
r) alkylaryl polyethoxy carboxylate ester,
s) tristyrylphenol alkoxylate phosphate esters,
t) tristyrylphenol alkoxylate carboxylate esters,
u) phosphate esters of block copolymers of ethylene and propylene oxide and
v) alkylpolyglucosides.

17. The composition as claimed in claim 1, wherein the alkaline buffer is
(a) ammonia or potassium or
(b) ammonia or potassium salts.

18. The composition as claimed in claim 1, wherein the alkaline buffer is an amine.

19. The composition as claimed in claim 18, wherein the alkaline buffer is a primary amine.

20. The composition as claimed in claim 18, wherein the alkaline buffer is a secondary amine.

21. A composition which comprises:
2,4-Dichlorophenoxyacetic acid in the iso-octyl ester form Dimethylamine,
Methylated fatty acid,
at least one surfactant
and optionally the dimethylamine salt of 2,4-Dichlorophenoxyacetic acid.

22. The composition as claimed in claim 1, wherein the amine is a tallowamine ethoxylate surfactant.
